(19) United States
(12) Patent Application Publication
(10) Pub. No.: US 2013/0195185 A1
(43) Pub. Date: Aug. 1, 2013

(54) APPARATUS AND METHOD FOR PROVIDING ADDITIONAL INFORMATION TO FUNCTIONAL UNIT IN RECONFIGURABLE CODEC

(71) Applicants: ELECTRONICS AND TELECOMMUNICATIONS RESEARCH INSTITUTE, Daejeon-city (KR); INDUSTRY-UNIVERSITY COOPERATION FOUNDATION HANYANG UNIVERSITY, Seoul (KR)

(72) Inventors: Seung-Wook LEE, Daejeon (KR); Ho-Won KIM, Seoul (KR); Ji-Hyung LEE, Daejeon (KR); Bon-Ki KOO, Daejeon (KR); Sin-Wook LEE, Seoul (KR); Euee-Seon JANG, Seoul (KR)

(73) Assignees: INDUSTRY-UNIVERSITY COOPERATION FOUNDATION HANYANG UNIVERSITY, Seoul (KR); ELECTRONICS AND TELECOMMUNICATIONS RESEARCH INSTITUTE, Daejeon-city (KR)

(21) Appl. No.: 13/755,420

(22) Filed: Jan. 31, 2013

(30) Foreign Application Priority Data
Feb. 1, 2012 (KR) 10-2012-0010533
Oct. 29, 2012 (KR) 10-2012-0120401

(51) Int. Cl. H04N 7/26

(52) U.S. Cl. CPC H04N 19/00569
USPC 375/240.12

(57) ABSTRACT

Disclosed herein is an apparatus and method for providing additional information to an FU in a reconfigurable codec. The apparatus includes a syntax parser, a prediction mode converter unit, and an inverse prediction unit. The syntax parser parses the encoding type value of a multimedia bit stream and a first prediction mode value from the multimedia bit stream. The prediction mode converter unit converts the first prediction mode value into a second prediction mode value corresponding to the encoding type value. The inverse prediction unit determines an inverse prediction operating mode based on the second prediction mode value.

### CROSS REFERENCE TO RELATED APPLICATIONS

This application claims the benefit of Korean Patent Application Nos. 10-2012-0010533 and 10-2012-0120401, filed on Feb. 1, 2012 and Oct. 29, 2012, respectively, which are hereby incorporated by reference in their entirety into this application.

### BACKGROUND OF THE INVENTION

1. Technical Field

The present invention relates generally to an apparatus and method for providing additional information to a Functional Unit (FU) in a reconfigurable codec and, more particularly, to a technology for inputting additional information into a Reconfigurable Video Coding (RVC) or Reconfigurable Graphics Coding (RGC)-related FU in the framework of a reconfigurable codec.

2. Description of the Related Art

In the MPEG Reconfigurable Video Coding (MPEG RVC) and MPEG Reconfigurable Graphics Coding (MPEG RGC) standards, various types of Functional Units (FUs) are defined, and the implementation of a codec based on the combination of the defined FUs is being standardized.

FIG. 1 is a block diagram illustrating a method of operating a conventional RVC framework

Referring to FIG. 1, the conventional RVC framework includes an RVC decoder 110, a decoder description (DD) processing unit 120, an FU network description (FND) storage unit 130, a bit stream syntax description (BSD) storage unit 140, and an FU set unit 150.

The RVC decoder 110 may receive a video bit stream, decode the input video bit stream, and output a decoded video file.

The DD processing unit 120 may provide design information that is used to design the RVC decoder 110.

Here, the design information includes a Bit stream Syntax Description (BSD) and an FU Network Description (FND).

An FND that is comprised of information representative of the relationship of connection between FUs, that is, the overall operation design of a codec, may be stored and managed in the FND storage unit 130, and a BSD that is comprised of information representative of the structure of a bit stream to be decoded may be stored and managed in the BSD storage unit 140.

The FU set unit 150 may store and manage at least one FU that is used to configure the RVC decoder 110.

Here, a function set unit that is used in a video codec is called a Video Tool Library (VTL), and a graphics-related function set unit is called a Graphics Tool Library (GTL). The VTL and the GTL are collectively called a Multimedia Tool Library (MTL).

In general, each FU that is used in an MTL is purposefully constructed to have a capability of being reused in various types of codecs.

Referring to FIG. 2, it is assumed that an inverse prediction FU for performing inverse prediction is constructed and performs three inverse prediction methods in accordance with the inverse prediction operating mode.

Inverse prediction refers to determining a decoding method in response to the type of codec and decoding the video data of a video bit stream using the determined decoding method.

When an operating mode is determined by a switch, results corresponding to each prediction mode can be obtained.

This prediction mode is defined by a token, and is input by a bit stream syntax parser. In this case, a problem may occur.

For example, in codec A, when a prediction mode corresponds to 3, an XOR prediction mode may operate. In contrast, in codec B, when a prediction mode is defined as 3, a parallelogram prediction mode may operate.

However, the inverse prediction FU should define a prediction mode so that a prediction operating mode desired by a user can be performed regardless of the type of codec.

Accordingly, a problem arises in that there is a need for a converter that reads the prediction mode value of a bit stream in accordance with a codec and converts the prediction mode value into a form that is suitable for the corresponding codec.

As another example, an entropy decoding method may be considered.

A conventional entropy decoder performs decoding based only on a given table. This has a problem of inefficiency because a user should define a new FU when the user performs the same task based on a new table.

That is, in order to perform entropy decoding, table information is required. In general, this information varies depending on the codec. Accordingly, a problem arises in that there is a need for a provider that provides a dictionary table (hereinafter also referred to as “table parameters”).

Furthermore, in order to design a new FU into which several FUs are combined, there is a need for an FU that is responsible for token management that is capable of processing tokens, such as combining, dividing and duplicating data.

Korean Patent Application Publication No. 2010-0000066 discloses an AVC adaptive moving image decoding apparatus and method. The technology disclosed in the Korean patent application publication is intended to provide an AVC adaptive decoding technology that adaptively configures a decoding process based on the encoding type of bit stream, but has limitations in that it cannot provide a technology for inputting additional information into the above-described RVC or RGC-related FU.

### SUMMARY OF THE INVENTION

Accordingly, the present invention has been made keeping in mind the above problems occurring in the prior art, and an object of the present invention is to provide a technology that reads the prediction mode value of a multimedia bit stream and converts the prediction mode value into a prediction mode value that is suitable for a corresponding codec.

Another object of the present invention is to provide a technology that provides table parameters in order to perform entropy decoding that is suitable for the type of codec.

Furthermore, another object of the present invention is to provide a technology that is related to an FU that is responsible for token management capable of processing tokens, such as combining, dividing and duplicating data.

In order to accomplish the above objects, the present invention provides an apparatus for providing additional information to an FU in a reconfigurable codec, including a syntax parser configured to parse the encoding type value of a multimedia bit stream and a first prediction mode value from the multimedia bit stream; a prediction mode converter unit configured to convert the first prediction mode value into a second prediction mode value corresponding to the encoding type value; and an inverse prediction unit configured to determine an inverse prediction operating mode based on the second prediction mode value.

The apparatus may further include a table-based entropy decoder configured to generate an entropy-decoded multimedia bit stream by performing entropy decoding on the multimedia bit stream; and a table provision unit configured to provide table parameters to the table-based entropy decoder; wherein the table-based entropy decoder determines the encoding type value of the multimedia bit stream based on the table parameters, and performs entropy decoding on the multimedia bit stream based on the encoding type value.

The syntax parser may parse a trigger value from the multimedia bit stream, and then transfer the trigger value to the table provision unit; and the table provision unit may be activated by the trigger value.

The apparatus may further include a division unit configured to divide the entropy-decoded multimedia bit stream with criteria of coordinate systems, and to provide obtained multimedia bit streams to the inverse prediction unit; and a duplication unit configured to duplicate the second prediction mode value, and to provide duplicated second prediction mode values to the inverse prediction unit; wherein the inverse prediction unit performs inverse prediction on each of the multimedia bit streams obtained for the respective coordinate systems based on each of the duplicated second prediction mode values, and outputs the multimedia bit streams on which inverse prediction has been performed for the respective coordinate systems.

The apparatus may further include a combination unit configured to combine the multimedia bit streams on which inverse prediction has been performed and to output the multimedia bit streams as a decoded multimedia.

The prediction mode converter unit may store a look-up table that determines the relationship of correspondence between the first prediction mode and the second prediction mode based on the encoding type value.

In order to accomplish the above objects, the present invention provides a method of providing additional information to an FU in a reconfigurable codec, including parsing, by a syntax parser, the encoding type value of a multimedia bit stream and a first prediction mode value from the multimedia bit stream; converting the first prediction mode value into a second prediction mode value corresponding to the encoding type value; and determining an inverse prediction operating mode based on the second prediction mode value.

The method may further include providing, by a table provision unit, table parameters to a table-based entropy decoder; determining the encoding type value of the multimedia bit stream based on the table parameters; and generating, by the table-based entropy decoder, an entropy-decoded multimedia bit stream by performing entropy decoding on the multimedia bit stream in accordance with the encoding type value.

The table provision unit may be activated by a trigger value that is parsed by the syntax parser.

The method may further include dividing the entropy-decoded multimedia bit stream with criteria of coordinate systems; duplicating the second prediction mode value; and performing inverse prediction on each of multimedia bit streams obtained for the respective coordinate systems based on each of duplicated second prediction mode values, and outputting the multimedia bit streams on which inverse prediction has been performed for the respective coordinate systems.

The method may further include combining the multimedia bit streams on which inverse prediction has been performed and then outputting the multimedia bit streams as a decoded multimedia.

Converting the first prediction mode value into a second prediction mode value corresponding to the encoding type value may be performed based on a look-up table that determines a relationship of correspondence between the first prediction mode and the second prediction mode based on the encoding type value.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating the configuration of a conventional RVC framework;

FIG. 2 is a diagram illustrating a conventional inverse prediction FU for performing inverse prediction;

FIG. 3 is a diagram illustrating the configuration of an apparatus for providing additional information to an FU in a reconfigurable codec in accordance with an embodiment of the present invention;

FIG. 4 is a diagram illustrating a configuration for performing the conversion of a prediction mode in accordance with an embodiment of the present invention;

FIG. 5 is a diagram illustrating a process of converting a prediction mode in accordance with an embodiment of the present invention;

FIG. 6 is a look-up table in accordance with an embodiment of the present invention;

FIG. 7 is a diagram illustrating a configuration for performing entropy decoding in accordance with an embodiment of the present invention;

FIG. 8 is a diagram illustrating a process of performing entropy decoding in accordance with an embodiment of the present invention;

FIG. 9 is a diagram illustrating the configurations of the management unit and the inverse prediction unit for performing inverse prediction through the division, duplication and combination of data in accordance with an embodiment of the present invention;

FIG. 10 is a diagram illustrating a process of performing inverse prediction through the division, duplication and combination of data in accordance with an embodiment of the present invention; and

FIG. 11 is a diagram illustrating the data flows of the apparatus for providing additional information to an FU in a reconfigurable codec in accordance with an embodiment of the present invention.

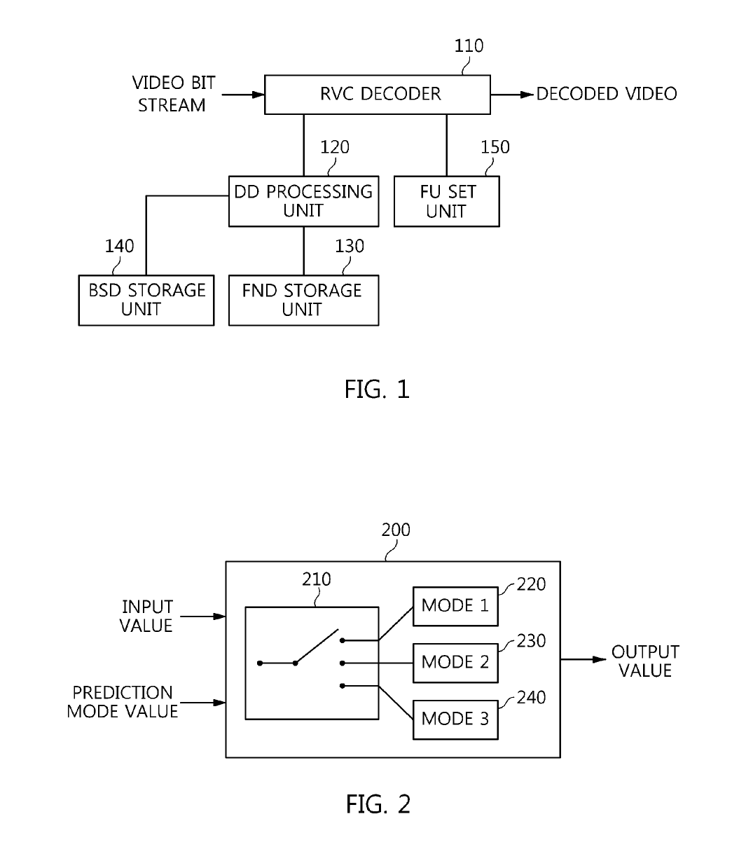

### DESCRIPTION OF THE PREFERRED EMBODIMENTS

The present invention will be described in detail below with reference to the accompanying drawings Repeated descriptions and descriptions of known functions and constructions which have been deemed to make the gist of the present invention unnecessarily vague will be omitted. The embodiments of the present invention are provided in order to fully describe the present invention to a person having ordinary knowledge in the art. Accordingly, the shapes, sizes, etc. of elements in the drawings may be exaggerated to make the description clear.

Embodiments of the present invention will be described in detail below with reference to the accompanying drawings.

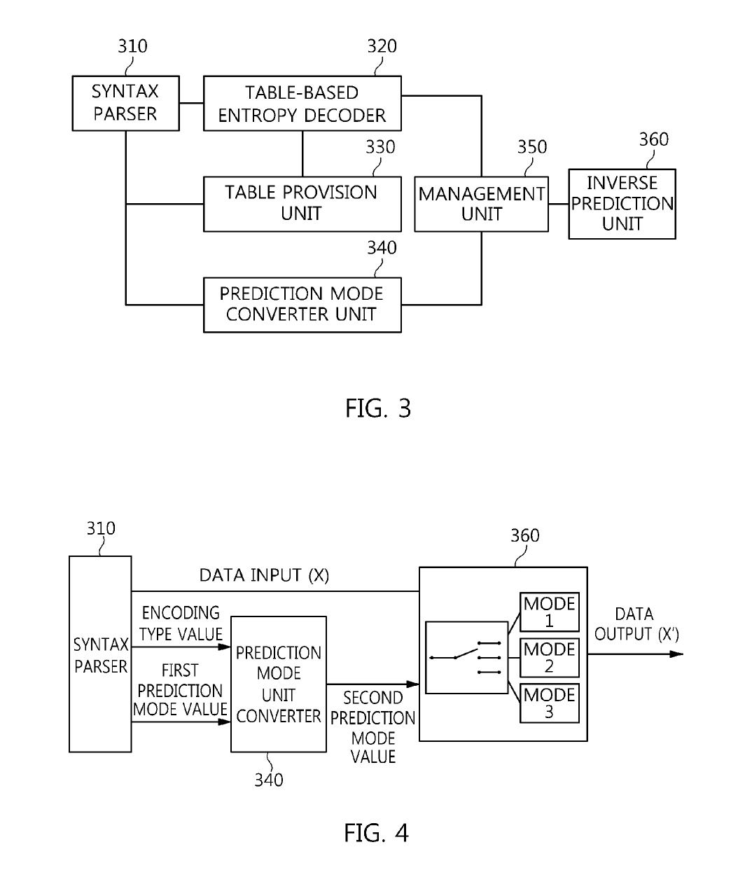

FIG. 3 is a diagram illustrating the configuration of an apparatus for providing additional information to an FU in a reconfigurable codec in accordance with an embodiment of the present invention.

Referring to FIG. 3, the apparatus for providing additional information to an FU in a reconfigurable codec in accordance with this embodiment of the present invention includes a syntax parser 310, a table-based entropy decoder 320, a table provision unit 330, a prediction mode converter unit 340, a management unit 350, and an inverse prediction unit 360.

The syntax parser 310 parses the encoding type value of a multimedia bit stream and a first prediction mode value from a multimedia bit stream.

The table-based entropy decoder 320 may perform entropy decoding on a multimedia bit stream.

The table provision unit 330 may provide table parameters to the entropy decoder 320.

The prediction mode converter unit 340 may convert the first prediction mode value parsed from the multimedia bit stream, into a second prediction mode value corresponding to the encoding type value of the multimedia bit stream.

Here, the prediction mode converter unit 340 may store a look-up table that determines the relationship of correspondence between the first prediction mode and the second prediction mode based on the type of encoding type value.

The management unit 350 may divide the entropy-decoded multimedia bit stream with criteria of coordinate systems, duplicate the second prediction mode value output from the prediction mode converter unit 340, and combine multimedia bit streams that have been obtained for the coordinate systems and have experienced inverse prediction.

Here, the management unit 350 may include a division unit 3510, a duplication unit 3520, and a combination unit 3530 that perform a division function, a duplication function, and a combination function, respectively.

The inverse prediction unit 360 may determine an inverse prediction operating mode based on the second prediction mode value that is obtained by the conversion.

The operating principles of the components of the apparatus for providing additional information to an FU in a reconfigurable codec in accordance with the embodiment of the present invention will be described in detail with reference to other drawings.

FIG. 4 is a diagram illustrating a configuration for performing the conversion of a prediction mode in accordance with an embodiment of the present invention.

The syntax parser 310 parses an encoding type value and a first prediction mode value by parsing a multimedia bit stream, and transfers them to the prediction mode converter unit 340.

Here, the multimedia bit stream data x is transferred to the inverse prediction unit 360.

The prediction mode converter unit 340 converts the first prediction mode value into a second prediction mode value that can be recognized by the inverse prediction unit 360, based on the transferred encoding type.

For example, if the encoding type, that is, the type of codec, is A when the encoding type of multimedia bit stream is A and 1 has been input as the first prediction mode value, the prediction mode value is converted into 2 so that an inverse prediction mode corresponding to codec A can operate in the inverse prediction unit 360, and 2 is output as the second prediction mode.

Here, as illustrated in FIG. 6, using the look-up table, the second prediction mode value may be caused to correspond to the first prediction mode value based on the type of codec.

Thereafter, the inverse prediction unit 360 determines an operating mode from among modes 1 to 3 based on the second prediction mode value, and performs inverse prediction in the determined mode.

Thereafter, the inverse prediction unit 360 outputs data x′ that is decoded as inverse prediction is performed.

Meanwhile, a method of transferring multimedia bit stream data x to the inverse prediction unit 360 through the prediction mode converter unit 340 may be employed.

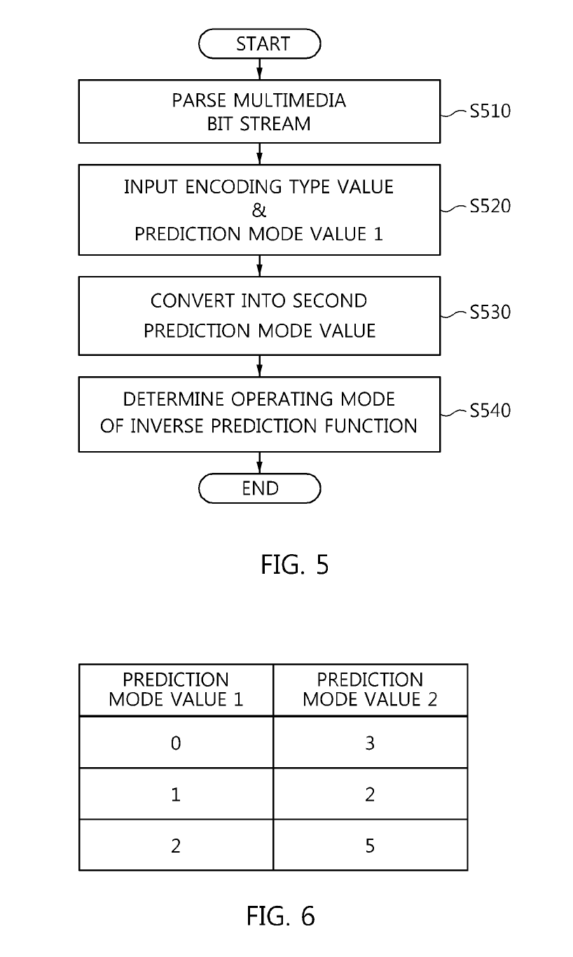

FIG. 5 is a diagram illustrating a process of converting a prediction mode in accordance with an embodiment of the present invention.

The syntax parser 310 parses an encoding type value and a first prediction mode value by parsing a multimedia bit stream and transfers them to the prediction mode converter unit 340 at steps S510 and S520.

Here, multimedia bit stream data x is transferred to the inverse prediction unit 360.

The prediction mode converter unit 340 converts the first prediction mode value into a second prediction mode value that can be recognized by the inverse prediction unit 360 based on the transferred encoding type at step S530

For example, if the encoding type, that is, the type of codec, is A when the encoding type of multimedia bit stream is A and 1 has been input as the first prediction mode value, the prediction mode value is converted into 2 so that an inverse prediction mode corresponding to codec A can operate in the inverse prediction unit 360, and 2 is output as the second prediction mode.

Here, as illustrated in FIG. 6, using the look-up table, the second prediction mode value may be caused to correspond to the first prediction mode value based on the type of codec.

Thereafter, the inverse prediction unit 360 determines an operating mode from among modes 1 to 3 based on the second prediction mode value and performs inverse prediction in the determined mode at step S540.

Thereafter, the inverse prediction unit 360 outputs data x′ that is decoded as inverse prediction is performed.

Meanwhile, a method of transferring multimedia bit stream data x to the inverse prediction unit 360 through the prediction mode converter unit 340 may be employed.

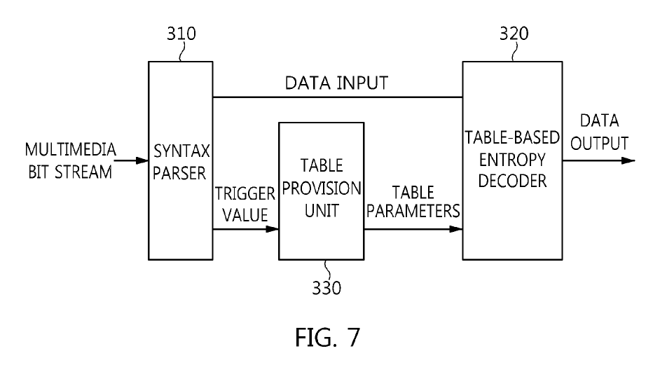

FIG. 7 is a diagram illustrating a configuration for performing entropy decoding in accordance with an embodiment of the present invention.

When a multimedia bit stream has been entropy-encoded, the syntax parser 310 parses a trigger value from the multimedia bit stream and transfers the trigger value to the table provision unit 330.

Furthermore, the multimedia bit stream is transferred to the table-based entropy decoder 320.

Here, the table-based entropy decoder 320 is activated by the trigger value, and the activated table-based entropy decoder 320 provides table parameters to the table-based entropy decoder 320.

Here, the table parameters may include a width used to represent the size of a table, a height, and table values used to define the actual values of the table.

Here, the table parameters are provided as the input tokens of the table-based entropy decoder 320.

Thereafter, the table-based entropy decoder 320 determines the encoding type value of the multimedia bit stream based on the table parameters transferred from the table provision unit 330, performs entropy decoding on the multimedia bit stream, that is, data transferred from the syntax parser 310, based on the encoding type, and outputs the results of the decoding.

Meanwhile, when the table-based entropy decoder 320 is designed as an entropy decoder capable of processing only 2D table parameters and table parameters are three-dimensional, a design may be implemented so that index values can be transferred from the syntax parser to the table provision unit in order to send only one of the table parameters that are held by the table provision unit 330.

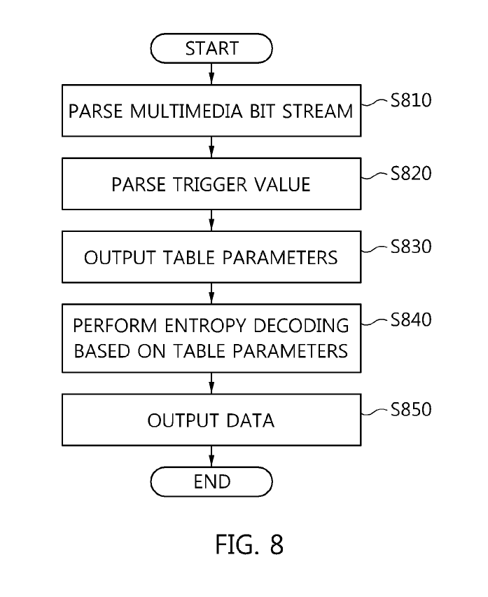

FIG. 8 is a diagram illustrating a process of performing entropy decoding in accordance with an embodiment of the present invention.

When a multimedia bit stream has been entropy-encoded, the syntax parser 310 parses a trigger value from the multimedia bit stream and transfers the trigger value to the table provision unit 330 at steps S810 and S820.

Furthermore, the multimedia bit stream is transferred to the table-based entropy decoder 320.

Here, the table-based entropy decoder 320 is activated by the trigger value and the activated table-based entropy decoder 320 provides table parameters to the table-based entropy decoder 320 at step S830.

Here, the table parameters may include a width used to represent the size of a table, a height, and table values used to define the actual values of the table.

Here, the table parameters are provided as the input tokens of the table-based entropy decoder 320.

Thereafter, the table-based entropy decoder 320 determines the encoding type value of the multimedia bit stream based on the table parameters transferred from the table provision unit 330, performs entropy decoding on the multimedia bit stream, that is, data transferred from the syntax parser 310, based on the encoding type, and outputs the results of the decoding at steps S840 and S850.

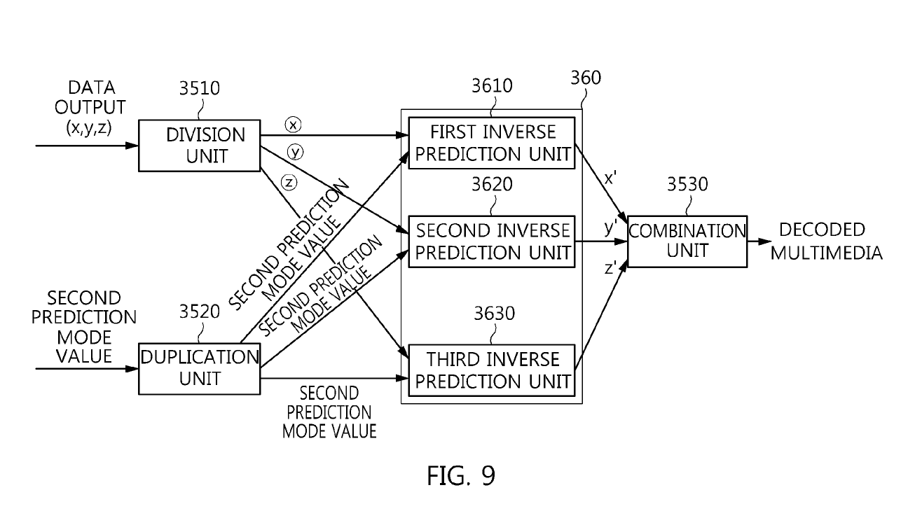

FIG. 9 is a diagram illustrating the configurations of the management unit and the inverse prediction unit for performing inverse prediction through the division, duplication and combination of data in accordance with an embodiment of the present invention.

It is assumed that an entropy-decoded multimedia bit stream output through the table-based entropy decoder 320 of FIG. 7 is data that has x, y and z coordinates.

The division unit 3510 may divide the output entropy-decoded multimedia bit stream into x, y and z coordinate systems.

Here, the number of input ports of the division unit 3510 is 1, the number of output ports may be provided in the form of a parameter, and the division unit 3510 divides the input data into a number of pieces of data equal to the number of output ports.

The inverse prediction unit 360 is configured to include first to third inverse prediction units 3610, 3620 and 3630, and the multimedia bit stream divided into the x, y and z coordinate systems is provided to the first to third inverse prediction units 3610, 3620 and 3630.

Meanwhile, the duplication unit 3520 receives the second prediction mode value from the prediction mode converter unit 340 of FIG. 4, and duplicates it.

Here, the number of input ports of the duplication unit 3520 is 1, the number of output ports may be provided in the form of a parameter, and the duplication unit 3520 duplicates the input data in a number of duplicates equal to the number of output ports.

The duplicated second prediction mode values are provided to the first to third inverse prediction units 3610, 3620 and 3630, respectively.

The first to third inverse prediction units 3610, 3620 and 3630 each determine an inverse prediction operating mode based on the provided multimedia bit stream and second prediction mode value, and output multimedia bit streams x′, y′ and z′ on which inverse prediction has been performed.

Thereafter, the combination unit 3530 combines the multimedia bit streams x′, y′ and z′ on which inverse prediction has been performed, into a single piece of data, and outputs the single piece of data as decoded multimedia data.

Here, the number of output ports of the combination unit 3530 is 1, the number of input ports may be provided in the form of a parameter, and the combination unit 3530 combines a number of pieces of input data equal to the number of input ports into a single piece of data.

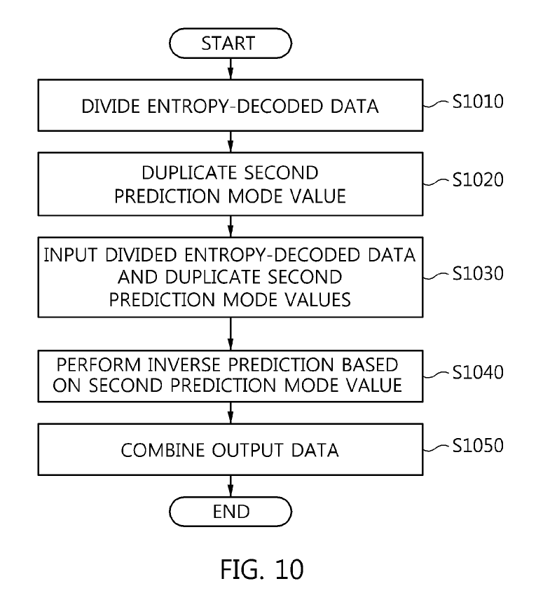

FIG. 10 is a diagram illustrating a process of performing inverse prediction through the division, duplication and combination of data in accordance with an embodiment of the present invention.

It is assumed that an entropy-decoded multimedia bit stream output through the table-based entropy decoder 320 of FIG. 7 is data having x, y and z coordinates.

The division unit 3510 may divide the output entropy-decoded multimedia bit stream into the x, y and z coordinate systems at step S1010.

Here, the number of input ports of the division unit 3510 is 1, the number of output ports may be provided in the form of a parameter, and the division unit 3510 divides the input data into a number of pieces of data equal to the number of output ports.

The inverse prediction unit 360 is configured to include the first to third inverse prediction units 3610, 3620 and 3630, and the multimedia bit stream divided into the x, y and z coordinate systems is provided to the first to third inverse prediction units 3610, 3620 and 3630 at step S1030.

Meanwhile, the duplication unit 3520 receives a second prediction mode value from the prediction mode converter unit 340 of FIG. 4 and duplicates the second prediction mode value at step S1020.

Here, the number of duplicates of the second prediction mode is preferably the number of coordinate systems.

Here, the number of input ports of the duplication unit 3520 is 1, the number of output ports may be provided in the form of a parameter, and the duplication unit 3520 duplicates the input data in a number of duplicates equal to the number of output ports.

The duplicated second prediction mode values are provided to the first to third inverse prediction units 3610, 3620 and 3630, respectively, at step S1030.

The first to third inverse prediction units 3610, 3620 and 3630 each determine an inverse prediction operating mode based on the provided multimedia bit stream and second prediction mode value, and output multimedia bit streams x′, y′ and z′ on which inverse prediction has been performed at step S1040.

Thereafter, the combination unit 3530 combines the multimedia bit streams x′, y′ and z′ on which inverse prediction has been performed, into a single piece of data and outputs the single piece of data as decoded multimedia data at step S1050.

Here, the number of output ports of the combination unit 3530 is 1, the number of input ports may be provided in the form of a parameter, and the combination unit 3530 combines a number of pieces of input data equal to the number of input ports into a single piece of data.

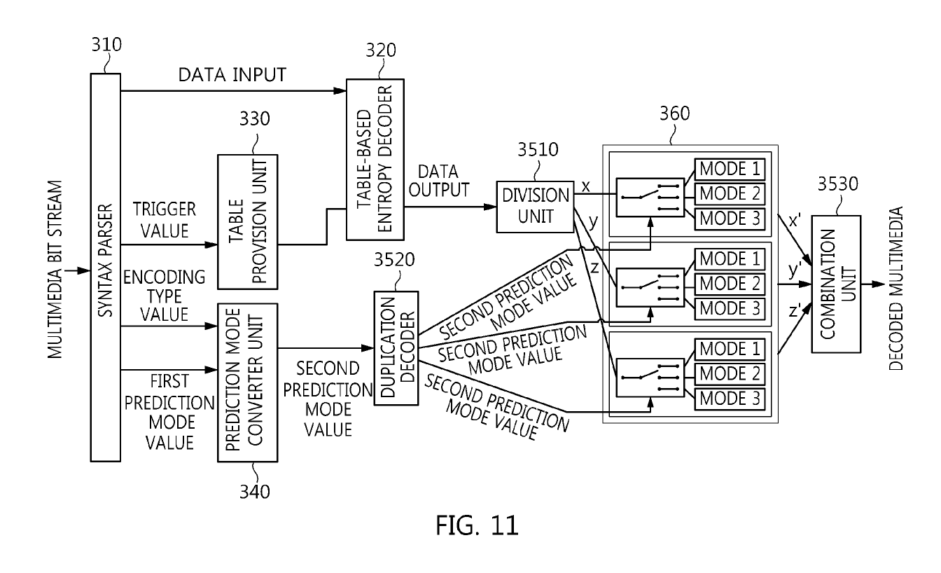

FIG. 11 is a diagram illustrating the data flows of the apparatus for providing additional information to an FU in a reconfigurable codec in accordance with an embodiment of the present invention.

FIG. 11 illustrates the data flows of the apparatus for providing additional information to an FU in a reconfigurable codec to which both an inverse prediction converter unit and an entropy decoder have been applied. The detailed descriptions of the operations of the components of the apparatus have been already given in conjunction with FIGS. 4 to 10.

Some steps of the present invention may be implemented as computer-readable code in a computer-readable storage medium. The computer-readable storage medium includes all types of storage devices in which computer system-readable data is stored. Examples of the computer-readable storage medium are Read Only Memory (ROM), Random Access Memory (RAM), Compact Disk-Read Only Memory (CD-ROM), magnetic tape, a floppy disk, and an optical data storage device. Furthermore, the computer-readable storage medium may be implemented as carrier waves (for example, in the case of transmission over the Internet). Moreover, the computer-readable medium may be distributed across computer systems connected via a network, so that computer-readable code can be stored and executed in a distributed manner.

In accordance with an embodiment of the present invention, there is achieved the advantage of performing decoding in an inverse prediction operating mode desired by a user regardless of the type of codec because the prediction mode value of a bit stream is read in response to the type of codec and is converted into a prediction mode value in a form that is suitable for the corresponding codec.

In accordance with an embodiment of the present invention, there is achieved the advantage of performing entropy decoding in accordance with the type of codec without defining a new FU for the type of table because an entropy decoding operating method is determined depending on the type of table parameter.

In accordance with an embodiment of the present invention, there is achieved the advantage of easily designing an FU into which various FUs are combined because data is combined, divided and duplicated by the management unit that is responsible for token management.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for providing additional information to a functional unit (FU) in a reconfigurable codec, comprising:
a syntax parser configured to parse an encoding type value of a multimedia bit stream and a first prediction mode value from the multimedia bit stream;
a prediction mode converter unit configured to convert the first prediction mode value into a second prediction mode value corresponding to the encoding type value; and
an inverse prediction unit configured to determine an inverse prediction operating mode based on the second prediction mode value.

2. The apparatus of claim 1, further comprising:
a table-based entropy decoder configured to generate an entropy-decoded multimedia bit stream by performing entropy decoding on the multimedia bit stream; and
a table provision unit configured to provide table parameters to the table-based entropy decoder;
wherein the table-based entropy decoder determines the encoding type value of the multimedia bit stream based on the table parameters, and performs entropy decoding on the multimedia bit stream based on the encoding type value.

3. The apparatus of claim 2, wherein:
the syntax parser parses a trigger value from the multimedia bit stream, and then transfers the trigger value to the table provision unit; and
the table provision unit is activated by the trigger value.

4. The apparatus of claim 2, further comprising:
a division unit configured to divide the entropy-decoded multimedia bit stream with criteria of coordinate systems, and to provide obtained multimedia bit streams to the inverse prediction unit; and
a duplication unit configured to duplicate the second prediction mode value, and to provide duplicated second prediction mode values to the inverse prediction unit;
wherein the inverse prediction unit performs inverse prediction on each of the multimedia bit streams obtained for the respective coordinate systems based on each of the duplicated second prediction mode values, and outputs the multimedia bit streams on which inverse prediction has been performed for the respective coordinate systems.

5. The apparatus of claim 4, further comprising a combination unit configured to combine the multimedia bit streams on which inverse prediction has been performed and to output the multimedia bit streams as a decoded multimedia.

6. The apparatus of claim 1, wherein the prediction mode converter unit stores a look-up table that determines a relationship of correspondence between the first prediction mode and the second prediction mode based on the encoding type value.

7. A method of providing additional information to an FU in a reconfigurable codec, comprising:
parsing, by a syntax parser, an encoding type value of a multimedia bit stream and a first prediction mode value from the multimedia bit stream;
converting the first prediction mode value into a second prediction mode value corresponding to the encoding type value; and
determining an inverse prediction operating mode based on the second prediction mode value.

8. The method of claim 7, further comprising:
providing, by a table provision unit, table parameters to a table-based entropy decoder;
determining the encoding type value of the multimedia bit stream based on the table parameters; and
generating, by the table-based entropy decoder, an entropy-decoded multimedia bit stream by performing entropy decoding on the multimedia bit stream in accordance with the encoding type value.

9. The method of claim 8, wherein the table provision unit is activated by a trigger value that is parsed by the syntax parser.

10. The method of claim 8, further comprising:
dividing the entropy-decoded multimedia bit stream with criteria of coordinate systems;
duplicating the second prediction mode value; and
performing inverse prediction on each of multimedia bit streams obtained for the respective coordinate systems based on each of duplicated second prediction mode values, and outputting the multimedia bit streams on which inverse prediction has been performed for the respective coordinate systems.

11. The method of claim 10, further comprising combining the multimedia bit streams on which inverse prediction has been performed and then outputting the multimedia bit streams as a decoded multimedia.

12. The method of claim 7, wherein converting the first prediction mode value into a second prediction mode value corresponding to the encoding type value is performed based on a look-up table that determines a relationship of correspondence between the first prediction mode and the second prediction mode based on the encoding type value.
